(19) United States
(12) Patent Application Publication
(10) Pub. No.: US 2012/0177238 A1
(43) Pub. Date: Jul. 12, 2012

(54) ACOUSTIC REPRODUCTION DEVICE

(76) Inventors: Akihiko Enamito, Kawasaki-shi (JP); Osamu Nishimura, Kawasaki-shi (JP); Takahiro Hiruma, Tokyo (JP)

(21) Appl. No.: 13/349,940

(22) Filed: Jan. 13, 2012

Related U.S. Application Data
(63) Continuation of application No. PCT/JP2009/062902, filed on Jul. 16, 2009.

(51) Int. Cl. H04R 1/20; H04R 1/02

(52) U.S. Cl. 381/349; 381/337

(57) ABSTRACT

According to one embodiment, an acoustic reproduction device includes a loudspeaker unit, a loudspeaker rear chamber unit, and a port unit. The loudspeaker unit generates a sound wave. The loudspeaker rear chamber unit includes a chamber portion in which the loudspeaker unit is arranged, and at least one of a duct portion and a branch portion. The duct portion and the branch portion each have a volume, a cross-sectional area, and a length different from those of the chamber portion. A port unit is connected to the loudspeaker rear chamber unit and has a port to externally output a rear wave. The duct portion guides the rear wave from the loudspeaker unit up to the port unit.

### CROSS REFERENCE TO RELATED APPLICATIONS

This application is a Continuation application of PCT Application No. PCT/JP2009/062902, filed Jul. 16, 2009, the entire contents of which are incorporated herein by reference.

### FIELD

Embodiments described herein relate generally to an AV sound of a flat-screen TV.

### BACKGROUND

There are a plurality of patent applications concerning low-frequency reproduction using Helmholtz resonance. These devices generally cause spatial resonance by forming a duct structure in part of a TV housing or implement two different resonance frequency bands by providing two resonance volumes. All the devices assume resonance excitation according to the principle of resonance (for example, JP-A 5-41896 (KOKAI)).

There is also a double loudspeaker driving method that provides a plurality of loudspeakers in an enclosure and changes the acoustic characteristics by active control (for example, Encyclopedia of Loudspeaker & Enclosure (Seibundo Sinkousha), 1999).

A loudspeaker system incorporated in a TV housing has only a limited loudspeaker installation space. For this reason, it is impossible to install a large-diameter loudspeaker unit that uses a normal audio loudspeaker and has sufficient low-frequency reproduction performance or a large-volume enclosure that allows to reproduce a lower frequency. This makes it difficult to reproduce a low frequency in an acoustic reproduction device using a small space. For example, the flatter the TV panel becomes, the more difficult low-frequency reproduction is.

### BRIEF DESCRIPTION OF THE DRAWINGS

FIG. 1 is a schematic view for explaining Helmholtz resonance amplification.

FIG. 2 is a schematic view of a bass-reflex loudspeaker using the principle of Helmholtz resonance.

FIG. 3 is a graph showing the frequency characteristic of the bass-reflex loudspeaker shown in FIG. 2.

FIGS. 4A and 4B illustrate schematic views of an acoustic reproduction device according to the first embodiment which has a step.

FIGS. 5A and 5B illustrate schematic views of an acoustic reproduction device according to the first embodiment which has a branch portion.

FIG. 6 is a schematic view for calculating the low resonance frequency of the stepped bass-reflex loudspeaker shown in FIGS. 4A and 4B.

FIGS. 7A and 7B illustrate views of how to install the port unit.

FIG. 8 is a view showing an example of dimensions to be used to calculate the low resonance frequency of a normal stepless bass-reflex loudspeaker.

FIG. 9 is a view showing an example of dimensions to be used to calculate the low resonance frequency of the stepped bass-reflex loudspeaker.

FIG. 10 is a graph showing the superiority of the stepped bass-reflex resonance frequency.

FIG. 11 illustrates graphs showing a total volume Vₐₗₗ of a loudspeaker rear chamber unit and a duct portion and an α value that is one index of the low-frequency flat response.

FIG. 12 is a graph of an α value by an equivalent air spring calculated from the air springs of the loudspeaker rear chamber unit and the duct portion by way of trial.

FIG. 13 is a graph of an α value by an air spring obtained from the total volume Vₐₗₗ of the loudspeaker rear chamber unit and the duct portion.

FIG. 14 is a graph showing the difference in the bass-reflex resonance frequency between a branched duct portion and a non-branched duct portion.

FIG. 15 is a graph showing the amount of a decrease in acoustic power caused by the difference in the cross-sectional area ratio between a cross-sectional area S₃ of the loudspeaker rear chamber unit and a cross-sectional area S₂ of the duct portion.

FIGS. 16A, 16B, 16C and 16D illustrate views showing variations of arranging a plurality of loudspeaker units in the loudspeaker rear chamber unit.

FIG. 17 is a view for explaining a problem posed when two loudspeaker units are spaced apart.

FIG. 18A is a schematic view of an acoustic reproduction device according to the second embodiment.

FIG. 18B is a view showing an acoustic reproduction device that solves the problem in FIG. 17.

FIG. 19 is a view showing an example when mounting the acoustic reproduction device shown in FIG. 18A or FIG. 18B.

FIG. 20 is a view showing detailed examples of dimensions when installing the acoustic reproduction device according to the second embodiment.

FIG. 21 is a graph showing the relationship between L₂ and the bass-reflex resonance frequency or α value to be used to obtain optimum L₂ in the acoustic reproduction device shown in FIG. 20.

FIG. 22 is a view showing an example when mounting the acoustic reproduction device shown in FIG. 20 on a TV.

### DETAILED DESCRIPTION

An acoustic reproduction device according to embodiments will now be described with reference to the accompanying drawings. Note that in the following embodiments, parts denoted by the same reference numerals perform the same operations, and a repetitive description thereof will be omitted.

In general, according to one embodiment, an acoustic reproduction device includes a loudspeaker unit, a loudspeaker rear chamber unit, and a port unit. The loudspeaker unit generates a sound wave. The loudspeaker rear chamber unit includes a chamber portion in which the loudspeaker unit is arranged, and at least one of a duct portion and a branch portion. The duct portion and the branch portion each have a volume, a cross-sectional area, and a length different from those of the chamber portion. A port unit is connected to the loudspeaker rear chamber unit and has a port to externally output a rear wave. The duct portion guides the rear wave from the loudspeaker unit up to the port unit.

The acoustic reproduction device of the embodiments can be arranged in a small space and can excellently reproduce a low frequency.

The general principle of low frequency amplification will be described first. One of amplification methods generally known in the acoustic and noise field is Helmholtz resonance amplification.

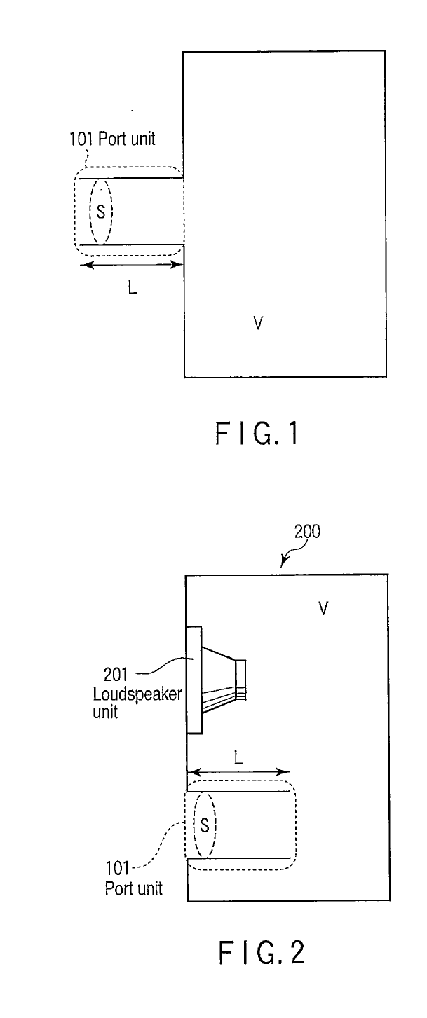

As shown in FIG. 1, a duct (also referred to as a port unit 101) having a length L and a cross-sectional area S is connected to a chamber portion having a volume V. When the spaces in the port unit 101 and the chamber portion are connected in the cross-sectional area S, a sound generated in the chamber portion is amplified by a resonance frequency given by

$${f}_{r} = \frac{c}{2 π} \sqrt{\frac{S}{V ( L + Δ L )}} ( Hz ) \qquad ( 1 )$$

where ΔL is a coefficient to be changed in accordance with the area S as open end correction. This amplification is the Helmholtz resonance amplification.

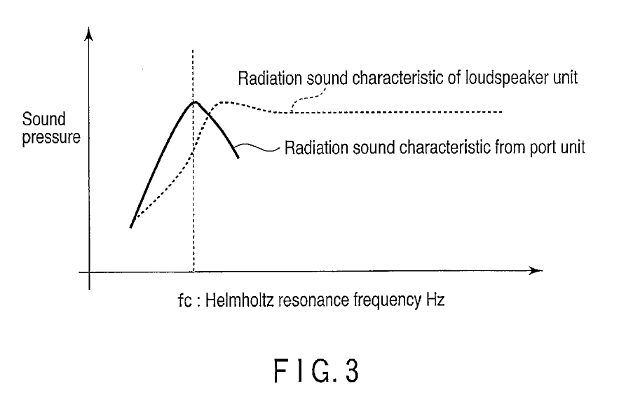

This principle is applied to a loudspeaker to obtain a bass-reflex loudspeaker shown in FIG. 2. This loudspeaker uses amplification that occurs when a sound radiated from the rear surface of a loudspeaker unit 201 serves as an excitation source and causes Helmholtz resonance in the port unit 101. Consequently, as shown in FIG. 3, although the radiation characteristic of a sound radiated from the loudspeaker itself does not reproduce a bass sound, as indicated by the dotted line, a sound radiated from the port unit 101 generates resonance, as indicated by the solid line. In front of the loudspeaker, both sounds are combined to reproduce a sound amplified in the lower frequency range.

### First Embodiment

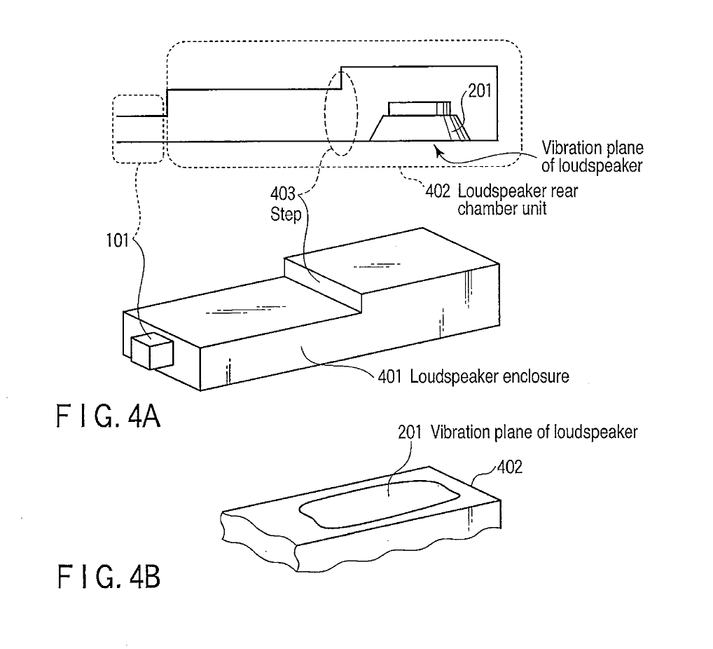

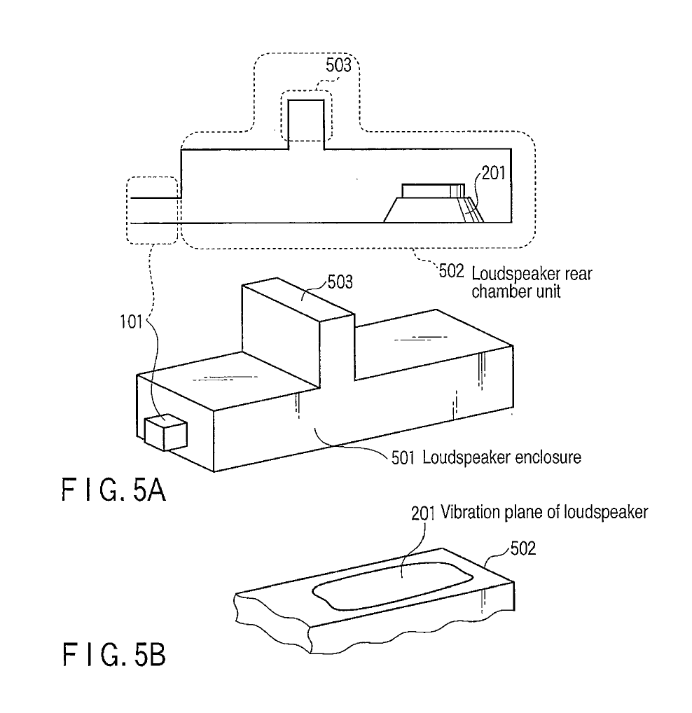

An acoustic reproduction device according to this embodiment will be described with reference to FIGS. 4A, 4B, 5A, and 5B.

The acoustic reproduction device of this embodiment includes a port unit 101, a loudspeaker unit 201, and a loudspeaker rear chamber unit 402. Note that the port unit 101 and the loudspeaker rear chamber unit 402 will generically be called a loudspeaker enclosure 401.

The loudspeaker unit 201 generates a sound not only from the vibration plane of the loudspeaker shown in FIG. 4B but also from the rear surface of the loudspeaker. The frequency of the sound wave from the vibration plane of the loudspeaker is higher than that of the rear wave. Note that FIG. 4B shows the loudspeaker rear chamber unit 402 observed from the lower side of FIG. 4A.

The loudspeaker rear chamber unit 402 having the loudspeaker unit 201 installed inside guides the rear wave generated by the loudspeaker unit 201 to the port unit 101. The loudspeaker rear chamber unit 402 has two chamber portions that are spatially continuous and have different volumes, lengths, and cross-sectional areas. The loudspeaker unit 201 is installed in one chamber portion. “Spatially continuous” means that sound waves propagate if there is a sound wave medium (for example, air) but no obstacle. The cross-sectional area of the first chamber portion within a range where the loudspeaker unit 201 is installed is different from that of the second chamber portion (also referred to as a duct portion) within a range between the first chamber portion and the port unit 101. As a result, a step is formed between the first chamber portion and the second chamber portion. For example, a rectangular step 403 is formed, as shown in FIG. 4A. To lower the frequency of a sound, the shape of the step need not be limited, but pieces of information about the lengths and cross-sectional areas of the port unit and the first and second chamber portions are necessary, as indicated from equation (2). The length represents the distance of each of the chamber portions and the port unit in the direction in which a sound wave propagates to the port unit as a whole. The cross-sectional area represents the area of a plane perpendicular to the length direction. In FIG. 4A, the length direction is the horizontal direction, and the cross-sectional area is parallel to the rectangular surface of the step 403.

The port unit 101 is spatially continuously connected to the loudspeaker rear chamber unit 402 and radiates sound from the side opposite to the surface connected to the loudspeaker rear chamber unit 402. A rear wave generated by the loudspeaker unit 201 is guided from the loudspeaker rear chamber unit 402 to the port unit 101 and externally radiated.

As compared to the normal stepless bass-reflex loudspeaker shown in FIG. 2, the acoustic reproduction device of this embodiment features the rectangular shape that allows arrangement in a small space. In other words, the acoustic reproduction device of this embodiment can be said to be a bass-reflex loudspeaker that takes advantage of the space in the gap between circuit boards and the like integrated in a flat-screen TV.

Unlike the conventional acoustic reproduction device that implements two resonance frequency bands by providing two resonance volumes, the acoustic reproduction device of this embodiment changes one resonance frequency by changing the cross-sectional area ratio.

As a modification of the acoustic reproduction device shown in FIGS. 4A and 4B, FIGS. 5A and 5B illustrates an acoustic reproduction device having a branch portion.

In this case, a loudspeaker rear chamber unit 502 including a branch portion 503 is installed in place of the loudspeaker rear chamber unit 402. The branch portion 503 only has an opening portion capable of spatially continuously receiving a rear wave from the loudspeaker unit 201 into the space of the branch portion 503. That is, the loudspeaker rear chamber unit 502 only has an opening portion at the portion connected to the port unit 101. The remaining parts of the acoustic reproduction device shown in FIGS. 5A and 5B are the same as those of the acoustic reproduction device shown in FIGS. 4A and 4B.

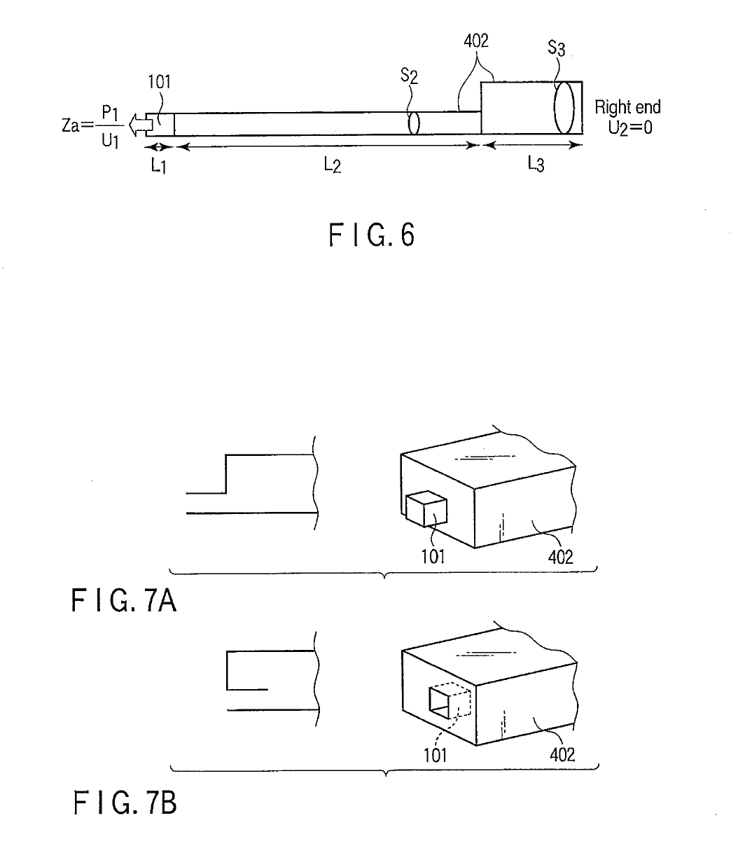

Calculations for obtaining the frequency of Helmholtz resonance in the port unit will be described next with reference to FIG. 6.

Unlike the conventional bass-reflex loudspeaker, the sound pressure and the volume velocity at the outlet of the port unit 101 in the rectangular stepped bass-reflex loudspeaker as shown in FIG. 6 are represented by equation (2). P₁ and U₁ of the left-hand side represent sound pressure 1 and volume velocity 1 at the outlet of the port unit 101. P₂ and U₂ of the right-hand side represent sound pressure 2 and volume velocity on the right wall of the loudspeaker rear chamber unit 402. The three matrices of equation (2) indicate, from the left, complex coefficients representing the transfer characteristics of propagation in the port unit, in the duct portion, and in the constant cross-sectional area space up to the step at the loudspeaker unit installation position of the loudspeaker rear chamber unit. In addition, k is the wave number, L₁, L₂, and L₃ are the lengths of the port unit, the duct portion, and the constant cross-sectional area space up to the step at the loudspeaker unit installation position of the loudspeaker rear chamber unit, S₁, S₂, and S₃ are the cross-sectional areas of these portions, j is the imaginary number, ρ is the density, and c is the sound velocity.

$$\begin{matrix}( \begin{matrix}{P}_{1} \\ {U}_{1}\end{matrix} ) = ( \begin{matrix}cos {kL}_{1} & j \frac{ρ c}{{S}_{1}} sin kL \\ j \frac{{S}_{1}}{ρ c} sin {kL}_{1} & cos {kL}_{1}\end{matrix} ) ( \begin{matrix}cos {kL}_{2} & j \frac{ρ c}{{S}_{2}} sin {kL}_{2} \\ j \frac{{S}_{2}}{ρ c} sin {kL}_{2} & cos {kL}_{2}\end{matrix} ) \\ ( \begin{matrix}cos {kL}_{3} & j \frac{ρ c}{{S}_{3}} sin {kL}_{3} \\ j \frac{{S}_{3}}{ρ c} sin {kL}_{3} & cos {kL}_{3}\end{matrix} ) ( \begin{matrix}{P}_{2} \\ {U}_{2}\end{matrix} ) \\ = ( \begin{matrix}A & B \\ C & D\end{matrix} ) ( \begin{matrix}{P}_{2} \\ {U}_{2}\end{matrix} )\end{matrix} \qquad ( 2 )$$

Since the side surface of the loudspeaker rear chamber unit is a close end (right end), the volume velocity U₂ is 0. Hence, an acoustic impedance Zₐ of the port unit is given by

$${Z}_{a} = \frac{{P}_{1}}{{U}_{1}} = \frac{j \{ 1 - \frac{{S}_{2}}{{S}_{1}} {kL}_{1} {kL}_{2} - {k}^{2} {S}_{3} {L}_{3} ( \frac{{L}_{1}}{{S}_{1}} + \frac{{L}_{2}}{{S}_{2}} ) \}}{- \frac{k}{ρ c} \{ ( {S}_{1} {L}_{1} + {S}_{2} {L}_{2} ) + ( 1 - \frac{{s}_{1}}{{S}_{2}} {kL}_{1} {kL}_{2} ) {S}_{3} {L}_{3} \}} \qquad ( 3 )$$

When acoustic impedance Zₐ is 0, Helmholtz resonance, that is, a bass-reflex resonance frequency is generated. Hence, f of

$$1 - \frac{{S}_{2}}{{S}_{1}} {kL}_{1} {kL}_{2} - {k}^{2} {S}_{3} {L}_{3} ( \frac{{L}_{1}}{{S}_{1}} + \frac{{L}_{2}}{{S}_{2}} ) = 0 \\ \begin{matrix}∴ f = \frac{c}{2 π} \sqrt{\frac{1}{\frac{{S}_{2}}{{S}_{1}} {L}_{1} {L}_{2} + {S}_{3} {L}_{3} ( \frac{{L}_{1}}{{S}_{1}} + \frac{{L}_{2}}{{S}_{2}} )}} \\ = \frac{c}{2 π} \sqrt{\frac{1}{γ \cdot {L}_{1} {L}_{2} + δ \cdot {L}_{3} ( γ \cdot {L}_{1} + {L}_{2} )}}\end{matrix} \\ γ = \frac{{S}_{2}}{{S}_{1}} , δ = \frac{{S}_{3}}{{S}_{2}} \qquad ( 4 )$$

is the bass-reflex resonance frequency.

Note that since the sound pressure cannot, in actuality, be completely 0 in accordance with the above theory, as described in “Encyclopedia of Loudspeaker & Enclosure (Seibundo Sinkousha), 1999”, open end correction is necessary, as in equation (1). That is, ΔL given by

$$Δ L = 2.9276 \sqrt{\frac{{S}_{1}}{π}} \qquad ( 5 )$$

is added to L₁ of equations (4). This correction is needed for comparison with an experimental value. Note that the meaning of equation (5) is described in “Encyclopedia of Loudspeaker & Enclosure (Seibundo Sinkousha), 1999”.

Hence, the larger the step and the cross-sectional area ratio are, the larger δ is, and the lower the bass-reflex resonance frequency f is so that a shift to the lower frequency side occurs, as is apparent. Note that the port unit 101 need not always project outward from the duct portion, as shown in FIG. 7A, like the structures adopted in FIGS. 4A, 4B, 5A, 5B, and 6, but may project into the duct portion, as shown in FIG. 7B.

For example, assume that γ=1 in equations (4), that is, the port unit 101 and the duct portion have the same cross-sectional area. An expression that satisfies the bass-reflex resonance frequency <f (Hz) is derived as

$${L}_{2} > \frac{1}{{L}_{1} + \frac{{S}_{3}}{{S}_{2}} {L}_{3}} \{ {( \frac{c}{2 π f} )}^{2} - ( \frac{{S}_{3}}{{S}_{2}} ) {L}_{1} {L}_{3} \} \qquad ( 6 )$$

Note that since the port unit 101 undergoes open end correction, L₁ is calculated by adding the length ΔL of open end correction represented by equation (5) to the actual port length of the port unit 101. That is, we obtain

$${L}_{2} > \frac{1}{( {L}_{1} + Δ L ) + \frac{{S}_{3}}{{S}_{2}} {L}_{3}} \{ {( \frac{c}{2 π f} )}^{2} - ( \frac{{S}_{3}}{{S}_{2}} ) ( {L}_{1} + Δ L ) {L}_{3} \} \qquad ( 7 )$$

When L₁, L₂, L₃, S₂, and S₃ satisfying inequality (6) are determined, the bass-reflex resonance frequency of the sound wave output from the port unit can be equal to or lower than f.

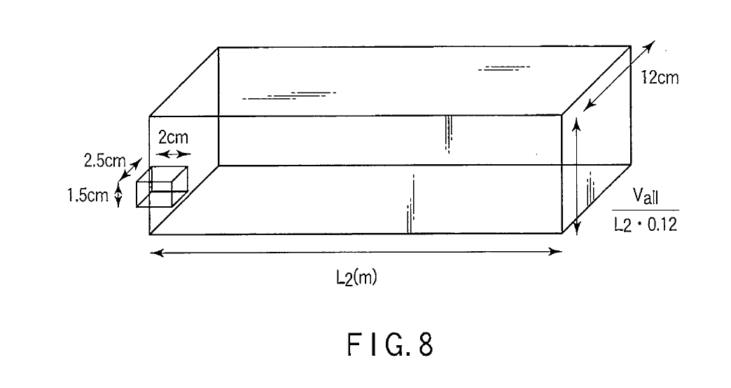

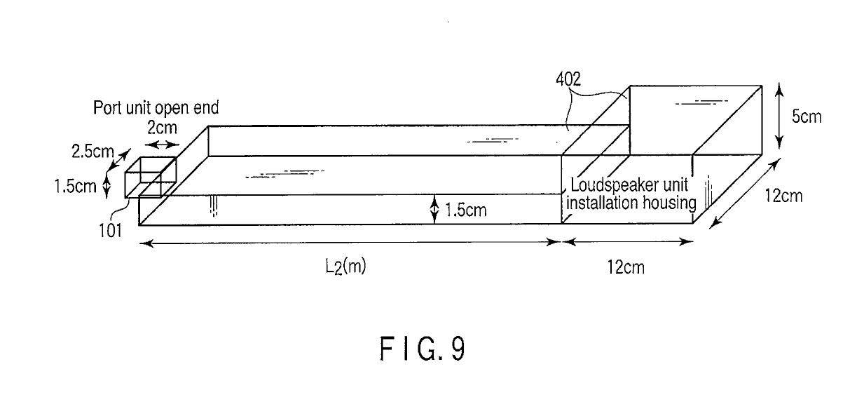

The low resonance frequency of the normal stepless bass-reflex loudspeaker and that of the stepped bass-reflex loudspeaker of the embodiment will be calculated and compared next. The calculation is done using, for example, the dimensions shown in FIGS. 8 and 9. In FIGS. 8 and 9, under the condition that a total volume Vₐₗₗ of the loudspeaker rear chamber unit is constant, a width of 12 cm is commonly fixed for both loudspeakers, and the length L₂ of the duct portion is changed. The transition of the bass-reflex resonance frequency in this case is calculated.

Since this calculation aims at relatively evaluating the ratio of the change, the open end correction at the opening portion of the port unit represented by equation (5) is not performed. Note that the port unit 101 is common to both loudspeakers. Hence, the total volume is given by

Vₐₗₗ=0.12×0.015×L₂+0.12×0.05×0.12=const (8)

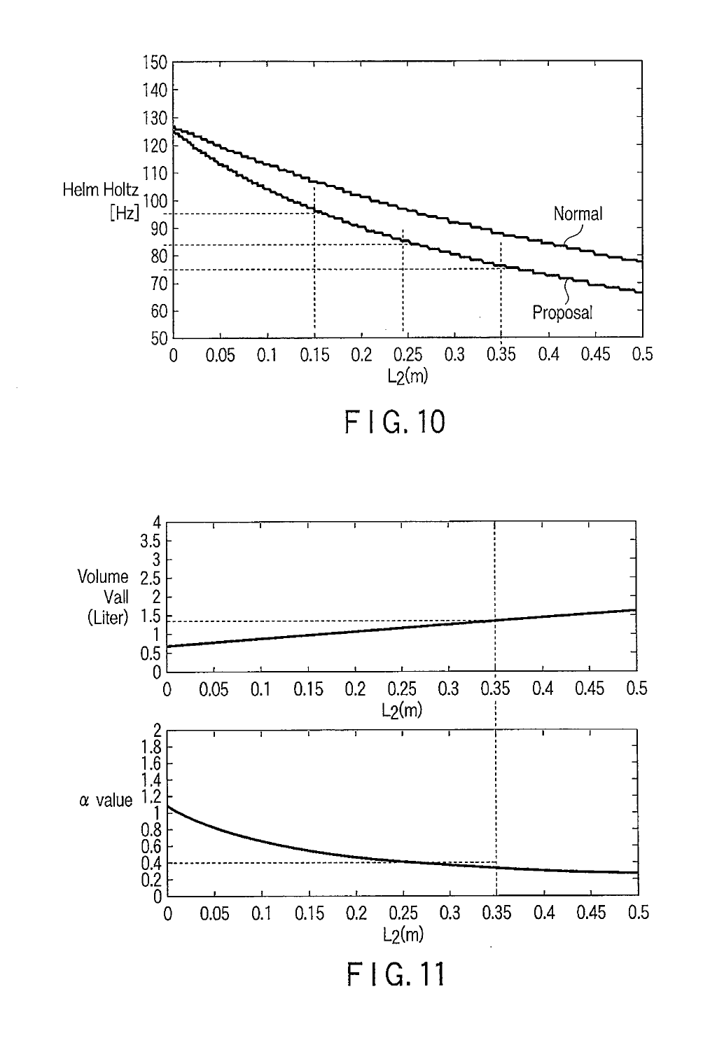

The results of simulations using the bass-reflex loudspeakers shown in FIGS. 8 and 9 will be described with reference to FIG. 10. In FIG. 10, the horizontal axis represents the length L₂ of the duct portion, and the vertical axis represents the bass-reflex resonance frequency.

Out of the graphs shown in FIG. 10, the graph that always exhibits a high bass-reflex resonance frequency at a certain length L₂ is the graph of the normal stepless bass-reflex loudspeaker. The graph that always exhibits a low bass-reflex resonance frequency at a certain length L₂ is the graph of the stepped bass-reflex loudspeaker of this embodiment. As can be seen from FIG. 10, the stepped bass-reflex loudspeaker of this embodiment always generates a low bass-reflex resonance frequency as compared to the normal stepless bass-reflex loudspeaker regardless of the length of the duct portion.

The α value that is an index of low-frequency flat response will be explained next with reference to FIGS. 11, 12, and 13. FIG. 11 illustrates graphs concerning the acoustic reproduction device of the embodiment. The upper graph of FIG. 11 plots the length L₂ of the duct portion along the horizontal axis and the total volume Vₐₗₗ of the loudspeaker rear chamber unit and the duct portion along the vertical axis. The lower graph of FIG. 11 shows the α value with respect to the length L₂.

The α value represents the ratio of the internal air spring K of the loudspeaker enclosure to a spring constant k of the vibration system of the single loudspeaker unit. The ideal α value is 0.5. 0.5≦α≦2 is supposedly suitable for low-frequency reproduction.

$$α = \frac{K}{k} = {( \frac{{f}_{0 C}}{{f}_{0}} )}^{2} - 1 = {( \frac{{Q}_{0 C}}{{Q}_{0}} )}^{2} - 1 \qquad ( 9 )$$

where Q_{0c} is the damping coefficient of the loudspeaker unit with a loudspeaker enclosure, and Q₀ is the damping coefficient of the single loudspeaker unit. The ideal value is Q_{0c}=0.7. 0.5≦Q_{0c}≦1 is supposedly suitable for reproduction performance. In addition, f₀ is the lowest resonance frequency of the loudspeaker unit, and f_{0c} is the resonance frequency when the loudspeaker enclosure is attached to the loudspeaker unit. Note that the spring constant k of the vibration system of the loudspeaker unit is the value obtained by actual measurement. The internal air spring K of the loudspeaker enclosure can approximately be calculated by

$$K = \frac{ρ {c}^{2} {S}_{u}^{2}}{V} \qquad ( 10 )$$

where Sᵤ is the equivalent vibration area. In FIG. 8, Sᵤ=Vₐₗₗ/L₂. The air springs of the loudspeaker rear chamber unit and the duct portion are calculated. An equivalent air spring K_{T} can be estimated from

$$f = \frac{c}{2 π} \sqrt{\frac{1}{\frac{{V}_{2} {L}_{1}}{{S}_{1}} + \frac{{V}_{3} {L}_{1}}{{S}_{1}} + \frac{{V}_{3} {L}_{2}}{{S}_{2}}}} = \frac{1}{2 π} \sqrt{\frac{{K}_{T}}{M}} \qquad ( 11 )$$

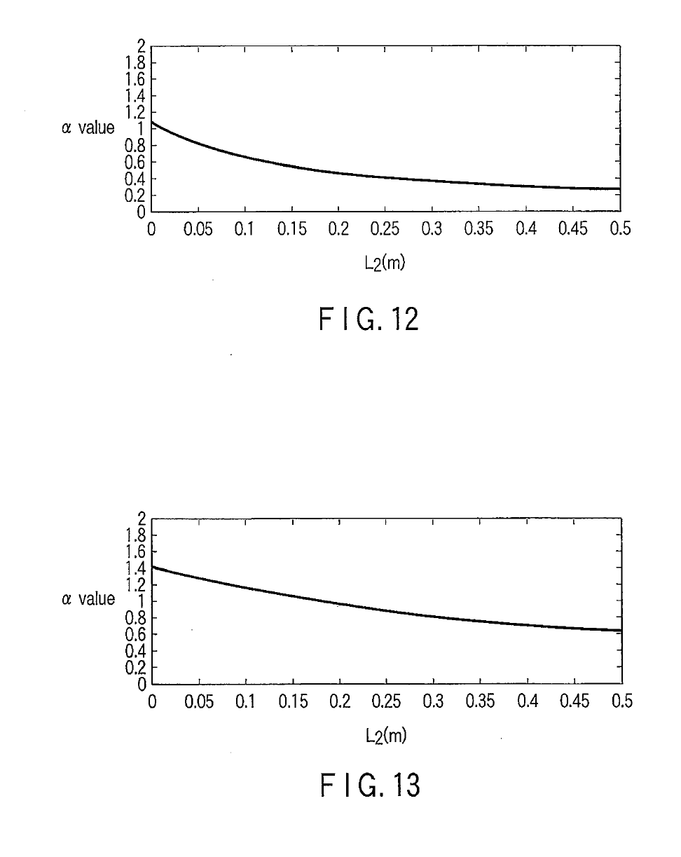

The graph of the α value in FIG. 11 is formed by obtaining K_{T} using equation (11) and plotting the value K_{T}/k obtained by dividing K_{T} by the actually measured value k. Note that the graph of FIG. 12 is the same as the lower graph of FIG. 11. On the other hand, FIG. 13 plots the α value with respect to the length L₂ of the duct portion in the normal stepless bass-reflex loudspeaker. The graph of the α value in FIG. 13 is formed by obtaining K using

$$K = \frac{ρ {c}^{2} {S}_{u}^{2}}{{V}_{all}} \qquad ( 12 )$$

temporarily using the total volume Vₐₗₗ of the loudspeaker rear chamber unit, like the normal stepless bass-reflex loudspeaker, and plotting the value K/k obtained by dividing K by the actually measured value k.

The α value in FIG. 13 is larger than that in FIG. 12. This reveals that the air spring is harder in the normal stepless bass-reflex loudspeaker than in the acoustic reproduction device of this embodiment. In other words, forming the step makes the air spring in the rectangular enclosure softer than that in the normal stepless bass-reflex loudspeaker. The weak air spring in the rectangular enclose can be explained by the direct connection of the air springs of the first chamber portion and the second chamber portion (duct portion). Hence, the space in the port unit has an air mass due to the air spring effect so as to allow low-frequency reproduction.

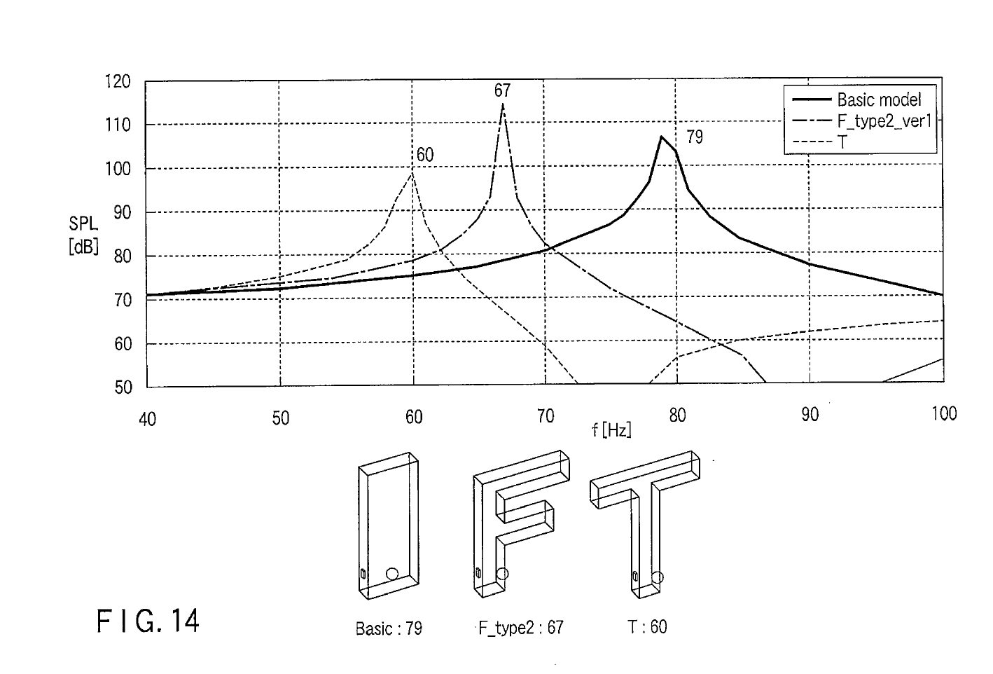

Note that if the branch portion 503 shown in FIGS. 5A and 5B exists in addition to the step, it has the effect of changing the bass-reflex resonance frequency as shown in FIG. 14, like the step. FIG. 14 shows the frequency distribution of the SPL (Sound Pressure Level) representing the sound pressure at the port unit for the normal stepless bass-reflex loudspeaker (Basic: 79) and two types of bass-reflex loudspeakers (F_type2: 67 and T: 60) having the branch portion 503 of this embodiment. As is apparent from FIG. 14, the distribution shifts to the lower frequency side in the bass-reflex loudspeakers having the branch portion 503 of this embodiment as compared to the stepless bass-reflex loudspeaker.

According to the above-described first embodiment, the low-frequency reproduction performance that affects the sound quality can be improved using the limited volume. In addition, as compared to the normal stepless bass-reflex loudspeaker, the acoustic reproduction device of this embodiment can be arranged in a small space and implement lower frequency reproduction by taking advantage of the space in the gap between circuit boards and the like integrated in a flat-screen TV because of the rectangular shape.

### Second Embodiment

In the acoustic reproduction device of the first embodiment, to use a limited space, a loudspeaker enclosure formed from a rectangular volume having a step or a branch portion is used as an enclosure conforming to the space. In this case, however, the sound hardly propagates at the step or branch portion. Although Helmholtz resonance occurs in the port unit, and a low frequency is reproduced at the step, the sound pressure is lower than that in the normal stepless bass-reflex loudspeaker without the step. In the rectangular bass-reflex design using a small space, the low-frequency reproduction and the sound pressure have a tradeoff relationship.

The acoustic reproduction device according to the second embodiment is different from that of the first embodiment in that a plurality of loudspeaker units are arranged in the loudspeaker rear chamber unit to raise the sound pressure.

An acoustic power W₀ of the sound source that propagates through the duct and an acoustic power W_{T} on a downstream cross section T can generally be given by

$${W}_{0} = \frac{1}{2} {Re [ {P}_{0} \cdot {U}_{0}^{*} ]}_{0} \\ {W}_{T} = \frac{1}{2} Re [ {P}_{T} \cdot {U}_{T}^{*} ] \qquad ( 13 )$$

where P₀ is the sound pressure near the sound source, U₀ is the particle velocity near the sound source, P_{T} is the sound pressure on the cross section T, and U_{T} is the particle velocity on the cross section T.
* represents performing a complex conjugate operation.

When the cross section T is located in the duct portion close to the loudspeaker unit, the amount of the decrease in the acoustic power propagating to the cross section T is given, based on the acoustic power of the sound source, by

$${η}_{Att} = 10 \cdot log ( \frac{{W}_{T}}{{W}_{0}} ) = - 20 log ( \frac{{S}_{3}}{{S}_{2}} ) + 20 log \vert sin {kL}_{3} \vert ( dB ) \qquad ( 14 )$$

The larger the cross-sectional area ratio of a cross-sectional area S₃ of the first chamber portion of the loudspeaker rear chamber unit to a cross-sectional area S₂ of the second chamber portion (duct portion) is, that is, the larger the step is, the more the acoustic power degrades.

For a lower frequency, the amount of the decrease in the acoustic power can be approximated to

$${η}_{Att} = 10 \cdot log ( \frac{{W}_{T}}{{W}_{0}} ) = - 20 log ( \frac{{S}_{3}}{{S}_{2}} ) + 20 log {kL}_{3} ( dB ) \qquad ( 15 )$$

When the cross section T is located in the duct portion close to the port unit, the amount of the decrease in the acoustic power input to the port unit for the lower frequency can be approximated, based on the acoustic power of the sound source, to

$${η}_{Att} = - 20 log \sqrt{{( - \frac{{S}_{3}}{{S}_{2}} {kL}_{2} {kL}_{3} )}^{2} + {( {( ρ c )}^{2} k \frac{{S}_{2} {L}_{2} + {S}_{3} {L}_{3}}{{S}_{2}} )}^{2}} + 20 log \vert \begin{matrix}( 1 - \frac{{S}_{3}}{{S}_{2}} {kL}_{2} {kL}_{3} ) ( 1 - \frac{{S}_{2}}{{S}_{3}} {kL}_{2} {kL}_{3} ) + \\ {( ρ ck )}^{2} ( \frac{{L}_{2}}{{S}_{2}} + \frac{{L}_{3}}{{S}_{3}} ) ( {S}_{2} {L}_{2} + {S}_{3} {L}_{3} )\end{matrix} \vert ( dB ) \qquad ( 16 )$$

Assume that the length L₂ of the duct portion is so short that it is negligible. When L₂=0 is substituted, we obtain

$$\begin{matrix}{η}_{Att} = - 20 {log ( ρ c )}^{2} k \frac{{S}_{3} {L}_{3}}{{S}_{2}} + 20 log \vert {( ρ ck )}^{2} {L}_{3}^{2} \vert \\ = - 20 log \frac{{( ρ c )}^{2} k \frac{{S}_{3} {L}_{3}}{{S}_{2}}}{\vert {( ρ ck )}^{2} {L}_{3}^{2} \vert} \\ = - 20 log \frac{\frac{{S}_{3}}{{S}_{2}}}{{kL}_{3}} \\ = - 20 log ( \frac{{S}_{3}}{{S}_{2}} ) + 20 log ( {kL}_{3} ) ( dB )\end{matrix} \qquad ( 17 )$$

that matches equation (15).

Referring back to equation (17), the larger the cross-sectional area ratio is, that is, the larger the step is, the more the acoustic power degrades.

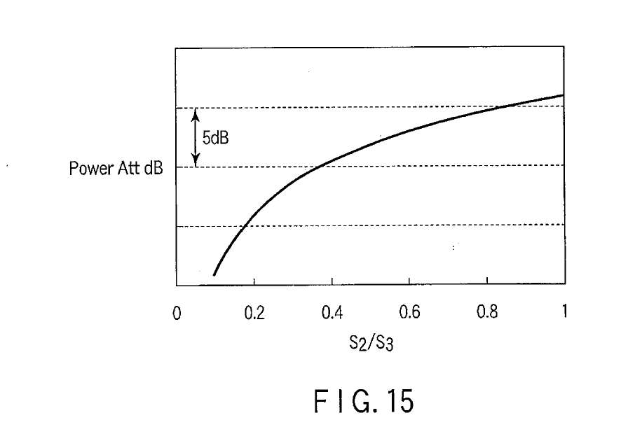

FIG. 15 shows the amount of the decrease in the acoustic power when the cross-sectional area ratio S₂/S₃ is changed. FIG. 15 shows the calculation result at 500 Hz when L₂=0.2 m, and L₃=0.1 m. As can be seen, the larger the cross-sectional area ratio is, that is, the smaller S₂/S₃ is, the more the decrease amount of the acoustic power itself is reduced. When S₂ increases to 0.1 times, the acoustic power decreases by about 15 dB, as compared to the stepless type in which S₂=S₃. Note that since the decrease amount difference of equation does not depend on a wave number k, it does not depend on the frequency, either, and the decrease amount difference is the same at 1,000 Hz and 2,000 Hz. In other words, even when the cross-sectional area ratio is changed, the shape of the frequency characteristic of the radiation sound output from the port unit can be maintained. To return the frequency characteristic with the gain lowered by the step to the original state, a measure for uniforming the frequency is necessary. For this purpose, a plurality of, for example, two sound sources having the same characteristic are preferably installed.

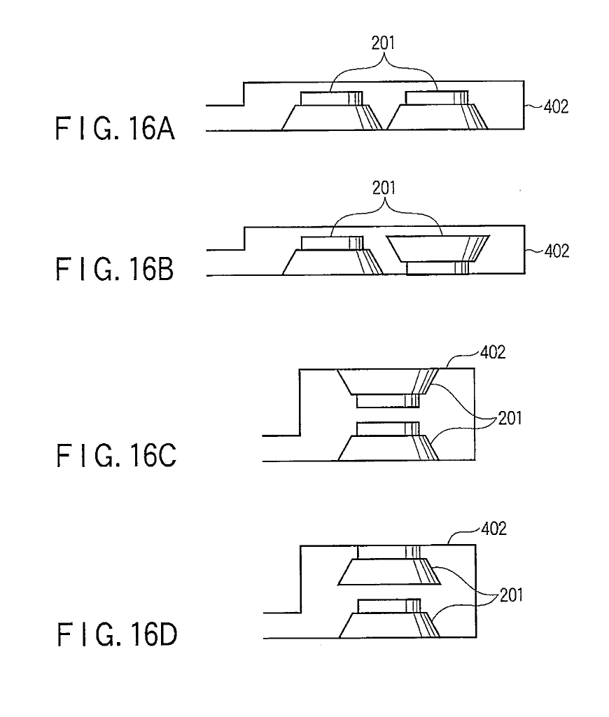

When arranging a plurality of loudspeaker units in the enclosure, a side-by-side arrangement (A) shown in FIGS. 16A, 16B, 16C and 16D is preferable for the above-described reason. However, the power can also be increased by adopting a tandem arrangement, arranging all the plurality of loudspeakers in the same direction, or installing one of the loudspeakers completely inside the enclosure.

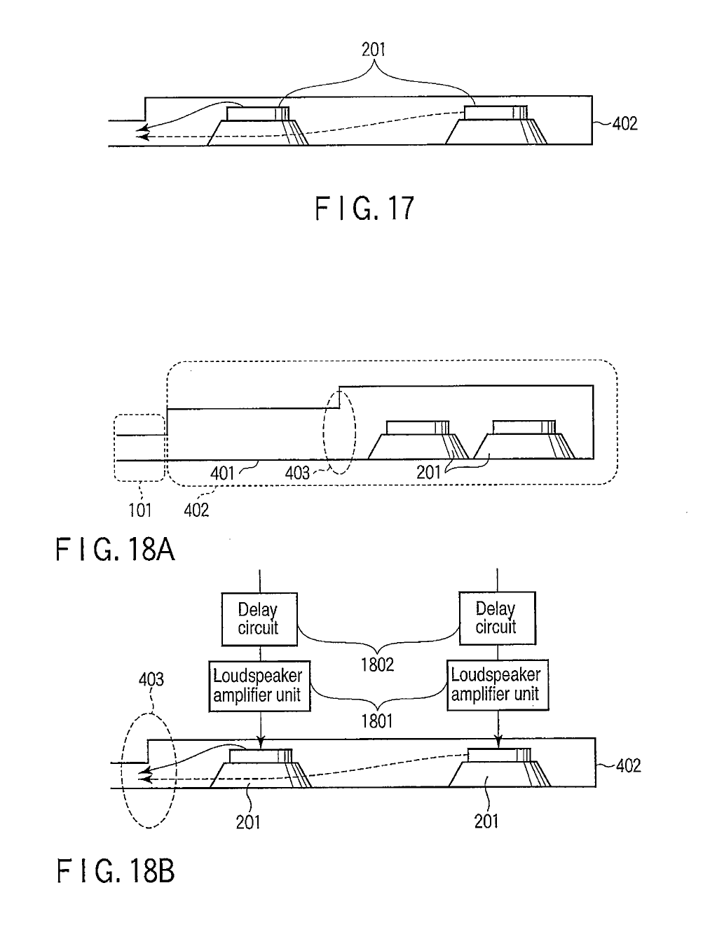

If the distance between the loudspeakers is too long, as shown in FIG. 17, the sound generated from the rear wave of the loudspeaker farther from the entrance of the duct portion, that is, a step 403 is smaller than the sound generated from the rear wave of the closer loudspeaker, and the phase is also shifted. To make all the rear waves of the plurality of loudspeakers have the same amplitude and the same phase, a delay circuit may be inserted in the preceding stage or succeeding stage of each loudspeaker amplifier unit so as to use the sound interference, thereby increasing the acoustic power. As shown in FIG. 18A, a plurality of loudspeaker units 201 are arranged in a loudspeaker enclosure 401. To cause all of the rear waves of the plurality of loudspeakers propagating from a loudspeaker rear chamber unit 402 to the entrance of the duct portion to have the same amplitude and the same phase, a delay circuit 1802 is provided at the preceding stage (or succeeding stage) of each loudspeaker amplifier unit 1801, as shown in FIG. 18B. This allows to increase the acoustic power of the rear wave of each loudspeaker and prevent the port radiation sound pressure from degrading at the step 403 or a branch portion 503. The degree of delay of the delay circuit 2002 is a design item that relates to the shapes of the loudspeaker units 201 and the loudspeaker rear chamber unit 402.

Note that if the branch portion 503 shown in FIGS. 5A and 5B exists in addition to the step, it has the effect of changing the bass-reflex resonance frequency to the lower frequency side, as shown in FIG. 14, like the step. In addition, since the acoustic power lowers, a plurality of loudspeaker units can effectively be arranged.

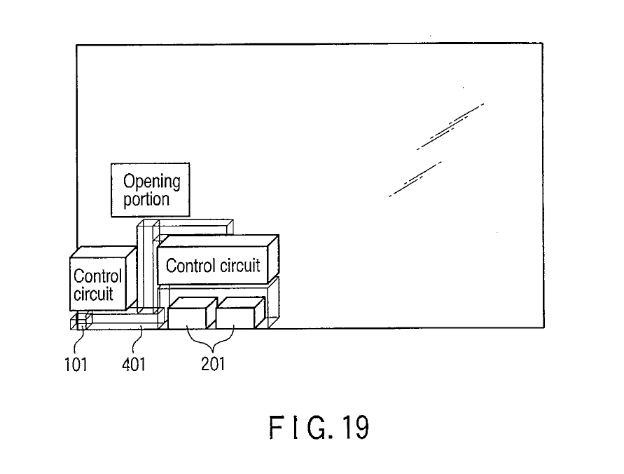

When the stepped or branched loudspeaker rear chamber unit is connected, as described above, a bass-reflex resonance loudspeaker with a branch portion can be incorporated effectively using the gap between the control circuits while ensuring indispensable spaces to, for example, arrange the control circuits and form the opening portion for heat dissipation, as shown in FIG. 19. This allows the flat small-volume loudspeaker to contribute to an increase in the sound volume in the lower frequency range.

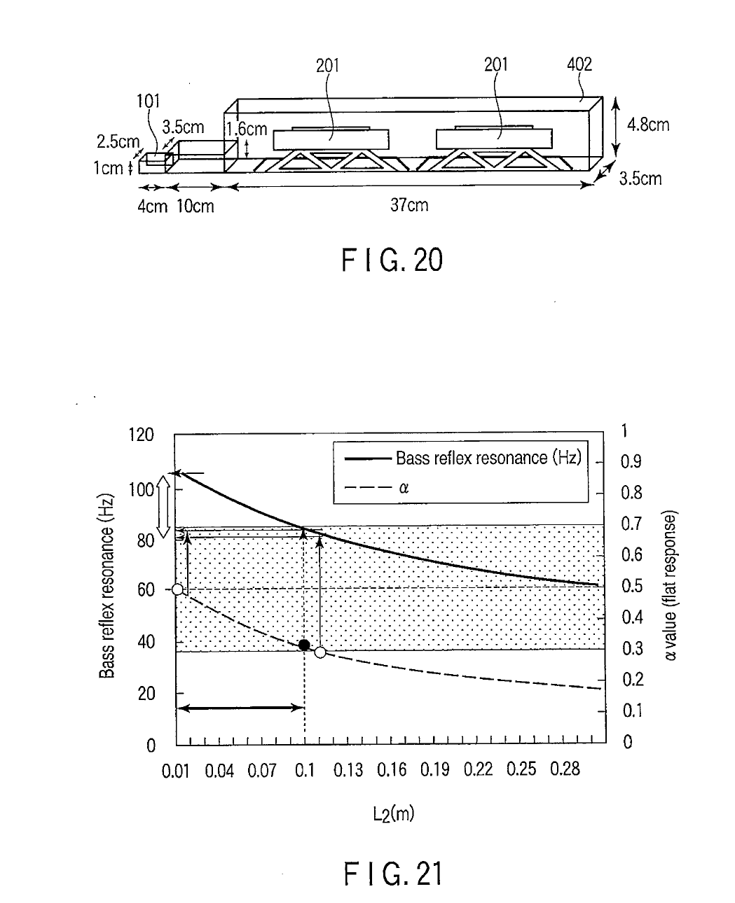

The guideline for design of the rectangular enclosure with focus on the cross-sectional area ratio will be described next with reference to FIGS. 20 and 21 using a detailed example.

How to determine the enclosure dimensions to make the α value serving as the guideline of the flat response closer to a preferable value when the low-frequency reproduction and the sound pressure have a tradeoff relationship will be explained.

When the cross-sectional area is increased, the bass-reflex resonance frequency can be obtained in a lower frequency range as compared to an enclosure having the same volume in the low-frequency reproduction. However, the sound is attenuated at the portion where the cross-sectional area ratio is generated, and the reproduced sound from the port unit consequently becomes small. Assume that two loudspeakers are installed to increase the sound volume at the generation source. For example, when two elliptical loudspeakers that are employed in many flat-screen TVs are arranged, the volume of the loudspeaker rear chamber unit is almost determined. If the loudspeakers are arranged with the faces down, as shown in FIG. 20, the width is 37 cm, the depth is 3.5 cm, and the height is 4.8 cm. The port unit 101 is assumed to have the volume generally used in a bass-reflex loudspeaker and a width of 4 cm, a depth of 2.5 cm, and a height of 1 cm. When the length of the duct portion is set as a variable (the depth of 3.6 cm, and the height is 1.6 cm), the bass-reflex resonance frequency represented by equations (4) and the α value given by equation (9) are obtained as shown in FIG. 21. The α value of equation (9) can be calculated using an equivalent spring constant K_{T} given by

$${K}_{T} = \frac{1}{( \frac{1}{{K}_{2}} + \frac{1}{{K}_{3}} + \frac{1}{{K}_{3}} ( \frac{{S}_{1} {L}_{2}}{{S}_{2} {L}_{1}} ) )} \qquad ( 18 )$$

obtained from equation (11) and a spring constant k of the loudspeaker unit of

$${f}_{0} = \frac{1}{2 π} \sqrt{\frac{k}{{m}_{0}}} \qquad ( 19 )$$

separately obtained using a vibrating mass m₀ and a resonance frequency f₀ of the loudspeaker unit. Note that in this case, open end correction represented by equation (5) is executed.

First, focus only on the bass-reflex frequency. The curve of the bass-reflex resonance indicated by the solid line on the upper side represents that the longer the length L₂ of the duct portion along the horizontal axis is, the lower the frequency along the left vertical axis is so that a low frequency up to 60 Hz can be reproduced. On the other hand, the longer the length L₂ of the duct portion along the horizontal axis is, the farther the α value along the right vertical axis is from the ideal value of 0.5. The α value decreases to about 0.2. Hence, even if bass-reflex resonance can be obtained near about 60 Hz by increasing the length by about 0.28 cm, damping acts, and the reproduction balance becomes poorer.

Hence, to obtain a bass-reflex resonance frequency of, for example, 80 Hz or less in consideration of the influence of the α value, a length of about 0.1 m indicated by the dotted line is appropriate. At this time, the α value is 0.3, as indicated by the filled circle. The α value remains at about 0.3 although not completely ideal. Hence, a good low-frequency reproduction balance can be obtained as compared to the case in which the length is increased to three times, that is, 0.3 m (about 60 Hz, α=0.2).

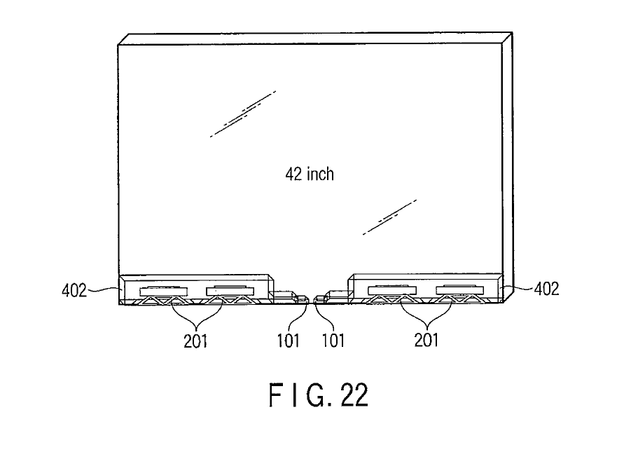

The duct portion shown in FIG. 20 has a size calculated based on the value. As a result, the total length including the port unit 101 and the loudspeaker rear chamber unit 402 is 51 cm. A 42-inch TV has a width of about 101 to 103 cm and can therefore incorporate the acoustic reproduction device, as shown in FIG. 22. Note that even when the TV size changes, the enclosure dimensions can approximately be calculated based on the above-described idea while balancing the low-frequency reproduction and the reproduced sound volume.

The acoustic reproduction device of the second embodiment may be recognized as being similar to the double loudspeaker driving method. However, the double loudspeaker driving method aims at removing the back pressure of the main loudspeaker by in-phase control of two loudspeakers and improving the characteristic of the minimum resonance frequency even in a small volume, unlike the acoustic reproduction device of the second embodiment which increases the acoustic power on the sound source side and thus increases the port radiation sound pressure.

According to the above-described second embodiment, it is possible to perform low-frequency reproduction while maintaining the sound pressure in a small space.

According to the above-described embodiments, the embodiments can provide a bass-reflex loudspeaker or an acoustic reproduction device that can be arranged in a small space because of the rectangular shape by taking advantage of the space in the gap between circuit boards and the like integrated in a flat-screen TV and implement lower frequency reproduction while maintaining the flat response and the sound pressure.

The acoustic reproduction device is used in an apparatus in which a loudspeaker needs to be installed in a small space where a large loudspeaker enclosure cannot be arranged. For example, the device can be incorporated in a flat-screen TV or applied to a small-sized loudspeaker.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An acoustic reproduction device comprising:
a loudspeaker unit configured to generate a sound wave;
a loudspeaker rear chamber unit comprising a chamber portion in which the loudspeaker unit is arranged, and at least one of a duct portion and a branch portion, the duct portion and the branch portion each having a volume, a cross-sectional area, and a length different from those of the chamber portion; and
a port unit connected to the loudspeaker rear chamber unit and having a port to externally output a rear wave, the duct portion guiding the rear wave from the loudspeaker unit up to the port unit.

2. The device according to claim 1, further comprising:
a plurality of loudspeaker units arranged in the loudspeaker rear chamber unit, the loudspeaker units each being the loudspeaker unit; and
a delay circuit configured to delay a signal to be output to the loudspeaker unit so that all of a plurality of rear waves from the loudspeaker units have the same amplitude and the same phase.

3. An acoustic reproduction device comprising:
a loudspeaker unit configured to generate a sound wave;
a loudspeaker rear chamber unit comprising a chamber portion in which the loudspeaker unit is arranged, and a duct portion whose volume, cross-sectional area, and length are different from those of the chamber portion; and
a port unit connected to the loudspeaker rear chamber unit and having a port to externally output a rear wave, the duct portion guiding the rear wave from the loudspeaker unit up to the port unit,
wherein letting L₁ and S₁ be a length and a cross-sectional area of the port unit, respectively, L₂ and S₂ be a length and a cross-sectional area of the duct portion, respectively, L₃ and S₃ be a length and a cross-sectional area of the loudspeaker rear chamber unit, respectively, c be a sound velocity, and π be a circular constant, L₂ satisfies
$$\begin{matrix}{L}_{2} > \frac{1}{( {L}_{1} + Δ L ) + \frac{{S}_{3}}{{S}_{2}} {L}_{3}} \{ {( \frac{c}{2 π f} )}^{2} - ( \frac{{S}_{3}}{{S}_{2}} ) ( {L}_{1} + Δ L ) {L}_{3} \} \\ and & ( 1 ) \\ Δ L = 2.9276 \sqrt{\frac{{S}_{1}}{π}} & ( 2 )\end{matrix}$$
to set a bass-reflex resonance frequency to not more than f.

4. The device according to claim 3, further comprising:
a plurality of loudspeaker units arranged in the loudspeaker rear chamber unit, the loudspeaker units each being the loudspeaker unit; and
a delay circuit configured to delay a signal to be output to the loudspeaker unit so that all of a plurality of rear waves from the loudspeaker units have the same amplitude and the same phase.

5. An acoustic reproduction device comprising:
means for generating a sound wave;
means for comprising a chamber portion in which the generating means is arranged, and at least one of a duct portion and a branch portion, the duct portion and the branch portion each having a volume, a cross-sectional area, and a length different from those of the chamber portion; and
means for being connected to the comprising means and having a port to externally output a rear wave, the duct portion guiding the rear wave from the generating means up to the port unit.

6. The device according to claim 5, further comprising:
a plurality of generating means arranged in the comprising means, the plurality of generating means each being the generating means; and
means for delaying a signal to be output to the comprising means so that all of a plurality of rear waves from the plurality of generating means have the same amplitude and the same phase.

7. An acoustic reproduction device comprising:
means for generating a sound wave;
means for comprising a chamber portion in which the generating means is arranged, and a duct portion whose volume, cross-sectional area, and length are different from those of the chamber portion; and
means for being connected to the comprising means and having a port to externally output a rear wave, the duct portion guiding the rear wave from the generating means up to the port unit,
wherein letting L₁ and S₁ be a length and a cross-sectional area of the being connected means, respectively, L₂ and S₂ be a length and a cross-sectional area of the duct portion, respectively, L₃ and S₃ be a length and a cross-sectional area of the comprising means, respectively, c be a sound velocity, and π be a circular constant, L₂ satisfies
$$\begin{matrix}{L}_{2} > \frac{1}{( {L}_{1} + Δ L ) + \frac{{S}_{3}}{{S}_{2}} {L}_{3}} \{ {( \frac{c}{2 π f} )}^{2} - ( \frac{{S}_{3}}{{S}_{2}} ) ( {L}_{1} + Δ L ) {L}_{3} \} \\ and & ( 1 ) \\ Δ L = 2.9276 \sqrt{\frac{{S}_{1}}{π}} & ( 2 )\end{matrix}$$
to set a bass-reflex resonance frequency to not more than f.

8. The device according to claim 7, further comprising:
a plurality of generating means arranged in the comprising means, the plurality of generating means each being the generating means; and
means for delaying a signal to be output to the comprising means so that all of a plurality of rear waves from the plurality of generating means have the same amplitude and the same phase.
